(19) United States
(12) Patent Application Publication
(10) Pub. No.: US 2010/0073174 A1
(43) Pub. Date: Mar. 25, 2010

(54) Wireless Smoke Detector Power Cut-Off System

(75) Inventor: George Dufour, Hawkesbury (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: 6036716 CANADA INC., Westmount, QC (CA)

(21) Appl. No.: 12/513,841

(22) PCT Filed: Nov. 7, 2007
(86) PCT No.: PCT/CA2007/002002

§ 371 Date: Nov. 23, 2009

Related U.S. Application Data
(60) Provisional application No. 60/857,135, filed on Nov. 7, 2006.

(30) Foreign Application Priority Data
Nov. 9, 2006 (CA) 2,567,691

(51) Int. Cl. G08B 17/10

(52) U.S. Cl. 340/628

(57) ABSTRACT

A power cut-off system for cutting a 220V power supply, or any other voltage value, of an electrical device, such as an oven for example, while maintaining a 110V power supply, or any other voltage value, to the electrical device, the system comprising a control-board unit connected to the 220V power supply of the electrical device and providing 110V and 220V respectively to the electrical device, the control-board unit including a transponder for sending and receiving wireless signals. The system also includes a smoke detector unit for detecting smoke and sending a wireless signal to the transponder of the control-board unit to cut-off the 220V power supply of the electrical device while maintaining the 110V power supply to the electrical device.

### CROSS-REFERENCE TO RELATED APPLICATIONS

This application is a National Stage of PCT/CA2007/002002 filed on Nov. 7, 2007, which claims priority to (1) Canadian Patent Application No. CA 2,567,691, filed on Nov. 9, 2006, and (2) U.S. Provisional Patent Application Serial No. 60/857,135, filed on Nov. 7, 2006, the disclosures of which are incorporated herein by reference in their entirety.

### FIELD OF THE INVENTION

The present invention relates to a system and to a method for cutting a power supply of a given voltage from an electrical device. More particularly, the present invention relates to a wireless smoke detector power cut-off system and to method of operation associated thereto.

### BACKGROUND OF THE INVENTION

Known in the art are heating appliances, such as electric cook-tops, electric ovens, or a combination thereof, which use electro-mechanical or electronic controls to program the operation of said appliances. It is also known in the art that these controls are generally proprietary to individual OEM manufacturers and are thus difficult to modify.

U.S. Pat. No. 6,140,620 granted to ALDRIDGE et al. on Oct. 31, 2000, relates to an appliance timer. This document teaches a device for disconnecting an electric appliance or a component thereof from a source of electricity including a circuit connecting the appliance or component thereof to a power source through a relay or other component to open the circuit, and a timer circuit connected to the relay. The timer circuit includes a processor for setting the timer circuit, and a manually operated switch in communication with the processor. The timer circuit is activated for a predetermined time increment by closing the switch, and the relay is closed while the timer circuit is activated. When the switch is closed again while the timer circuit is activated, an additional time increment is added to the activation period.

It is also known that conventional devices such as the above-described can automatically disconnect an appliance from the source of electrical current after a preset period of time. Typically, the device is installed between the electrical cord of the appliance and a 220V electrical outlet to which the cooking appliance is usually plugged. The device is designed to disconnect the electric appliance such as a stove through a relay. The device automatically disconnects the appliance from the power source after a preset period of time, unless the user presses a switch, in which case a timer circuit is reset and a new countdown period is initiated, or alternately a specific time period is added to the remaining time period counted by the timer circuit each time the switch is operated, until a maximum time period is reached. However, important drawbacks associated with this type of device are that the activation period is permitted until a maximum time is reached and that lines L1 and L2 are completely disconnected from the 220VAC source so that the entire appliance is shut down.

Also known to the Applicant is Canadian patent application No. 2,498,227 published on Aug. 21, 2006. This safety device complements the electro-mechanical or electronic controls for home appliances so as to eliminate fire hazard situation when the heating elements are running out of control due to failure of the control elements or when a user is not present and the temperature reaches the fire condition. In particular, the safety device is designed so that the 120V-operated equipment of the appliance is unaffected by it, but is not optimal for other applications or situations.

Hence, in light of the aforementioned, there is a need for an improved system, which by virtue of its design and components, would be able to overcome some of the above-discussed prior art problems.

### SUMMARY OF THE INVENTION

The object of the present invention is to provide a system which, by virtue of its design and components, satisfies some of the above-mentioned needs and is thus an improvement over other related systems and/or methods known in the prior art.

In accordance with the present invention, the above object is achieved, as will be easily understood, with a system such as the one briefly described herein and such as the one exemplified in the accompanying drawings.

More particularly, according to the present invention, there is provided a power cut-off system for cutting a power supply of a given voltage from an electrical device present in a first environment, the system comprising:

a control-board unit operatively connected to the power supply of the electrical device, the control-board unit including a transponder for sending and receiving wireless signals; and

a smoke detector operatively connected to the control-board unit and configured for detecting levels of smoke in a second environment and sending at least one wireless signal to the control-board unit in order to cut-off the power supply of the electrical device upon attainment of a given threshold of smoke level in the second environment.

Preferably, the power supply includes main and auxiliary power supplies for providing main and auxiliary sources of power supply to the electrical device.

Preferably also, the control-board unit is operatively connected to the main power supply of the electrical device, and the smoke detector is further configured for sending at least one wireless signal to the transponder of the control-board unit in order to cut-off the main power supply of the electrical device while maintaining the auxiliary power supply thereof upon attainment of the given threshold of smoke level in the second environment.

Preferably, the main and auxiliary power supplies provide voltages of different values. Preferably also, the voltage of the auxiliary power supply is lower than the voltage of the main power supply. According to a preferred embodiment of the present invention, the main and auxiliary power supplies provide voltages of about 220V and about 110V respectively.

Preferably, the control-board unit includes a control-board that is integrated into a power cord of the electrical device.

Preferably also, the electrical device is a household electrical device, such as an oven, a stove, a cook-top and/or the like.

The first environment and the second environment may be different environments (e.g. different rooms, etc.), but according to a preferred embodiment of the present invention, the first environment and the second environment are the same room environment.

According to yet another aspect of the present invention, there is also provided a method of cutting a power supply of a given voltage from an electrical device present in a first environment, the method comprising the steps of

a) providing a control-board unit operatively connected to the power supply of the electrical device, the control-board unit including a transponder for sending and receiving wireless signals; and

b) providing a smoke detector operatively connected to the control-board unit and configured for detecting levels of smoke in a second environment and sending at least one wireless signal to the control-board unit in order to cut-off the power supply of the electrical device upon attainment of a given threshold of smoke level in the second environment.

According to yet another aspect of the present invention, there is also provided a kit for assembling the above-mentioned system.

According to yet another aspect of the present invention, there is also provided a method for assembling components of the above-mentioned kit.

The objects, advantages and other features of the present invention will become more apparent upon reading of the following non-restrictive description of preferred embodiments thereof, given for the purpose of exemplification only, with reference to the accompanying drawings.

### BRIEF DESCRIPTION OF THE DRAWINGS

FIG. 1 is an electric block diagram of a fire hazard safety device according to the prior art.

FIG. 2 is a top perspective view of a front part of a fire hazard safety device according to the prior art.

FIG. 3 is a top perspective view of back part of a fire hazard safety device that is connectable to the front part shown in FIG. 2.

FIG. 4 is a perspective view of a remote command key transmitter that may be used with a fire hazard safety device according to the prior art.

FIG. 5 is a back perspective view of a control board of a fire hazard safety device according to the prior art.

FIG. 6 is a front perspective view of the control board shown in FIG. 5.

FIG. 7 is a side view of a modified oven cord including the safety device control-board shown in FIGS. 5 and 6, according to a preferred embodiment of the present invention.

FIG. 8 is a schematic diagram of a wireless smoke detector power cut-off system according to a preferred embodiment of the present invention.

FIG. 9 is a front view of a wireless smoke detector transmitter according to a preferred embodiment of the present invention.

FIG. 10 is a back view of the wireless smoke detector transmitter shown in FIG. 9.

FIG. 11 is a perspective view of the wireless smoke detector transmitter shown in FIG. 9, being positioned inside a housing.

### DETAILED DESCRIPTION OF PREFERRED EMBODIMENTS OF THE INVENTION

In the following description, the same numerical references refer to similar elements. The embodiments, dimensions, components and/or geometrical configurations shown in the figures are preferred, for exemplification purposes only.

In the context of the present description, the expression “system” or “detector” includes all types of devices used for detecting the presence of an unwanted or undesirable condition, such as the presence of smoke in a given room, or the presence of carbon monoxide, and the like. Moreover, although the present invention was primarily designed for detecting the presence of smoke in a given room environment, and to be used with household appliances, it may be used in other types of environments, and with other kinds of items, or for other usages requiring a cut-off of a power supply of a given voltage from a given electrical device, as apparent to a person skilled in the art. For this reason, the expressions “smoke”, “detector”, “home”, “household”, “appliance”, etc. should not be taken as to limit the scope of the present invention and include all other kinds of usages or items with which the present invention may be used and could be useful.

Moreover, in the context of the present description, the expressions “system”, “detector”, “cord”, “device”, “assembly”, “apparatus”, “equipment” and “unit”, as well as any other equivalent expressions and/or compound words thereof, may be used interchangeably. The same applies for any other mutually equivalent expressions, such as “detecting”, “monitoring” and “identifying”, for example, as well as “smoke” and “undesirable substance”, as apparent to a person skilled in the art.

In addition, although the preferred embodiments of the present invention as illustrated in the accompanying drawings comprise various components, and although the preferred embodiments of the system and corresponding parts of the present invention as shown consist of certain geometrical configurations as explained and illustrated herein, not all of these components and geometries are essential to the invention and thus should not be taken in their restrictive sense, i.e. should not be taken as to limit the scope of the present invention. It is to be understood, as also apparent to a person skilled in the art, that other suitable components and cooperations therein between, as well as other suitable geometrical configurations may be used for the system according to the present invention, as will be briefly explained herein and as can be easily inferred herefrom by a person skilled in the art, without departing from the scope of the invention.

Broadly described, and as can be easily understood by a person skilled in the art in view of the accompanying drawings, the present invention provides a power cut-off system for cutting a power supply from an electrical device. The system preferably comprises a control unit connected to the power supply of the electrical device, the control unit including a transponder for sending and receiving wireless signals. The system also comprises a smoke detector unit for detecting smoke and sending a wireless signal to the control unit to cut-off the power supply of the electrical device, under given conditions. Preferably, the present system is used as a safety device that is installed between the electrical cord of a household appliance, such as an oven and/or stove elements, for example, and a 220V electrical outlet to which the appliance is usually plugged.

Indeed, according to a preferred aspect of the present invention, there is provided a power cut-off system for cutting a 220V power supply (or any other voltage value) to an electrical device (for example, an oven) while maintaining a 110V power supply (or any other voltage value) to the electrical device, the system comprising a control unit connected to the 220V power supply of the electrical device and providing 110V and 220V to the electrical device, the control-board unit including a transponder for sending and receiving wireless signals. The system also preferably comprises a smoke detector unit for detecting smoke and sending a wireless signal to the transponder of the control unit to cut-off the 220V power supply to the electrical device while maintaining the 110V power supply to the electrical device.

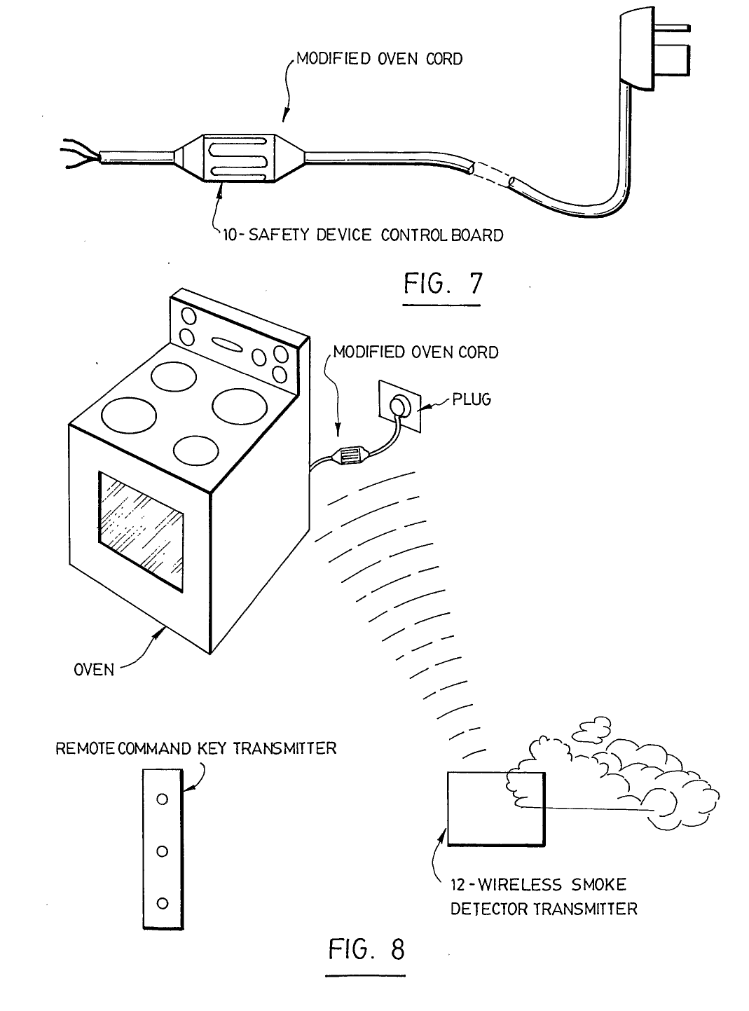

Preferably also, the control-board unit includes a control-board that is integrated in the power cord of the electrical device (e.g. modified oven cord), as can be easily understood by a person skilled in the art in view of FIGS. 7 and 8.

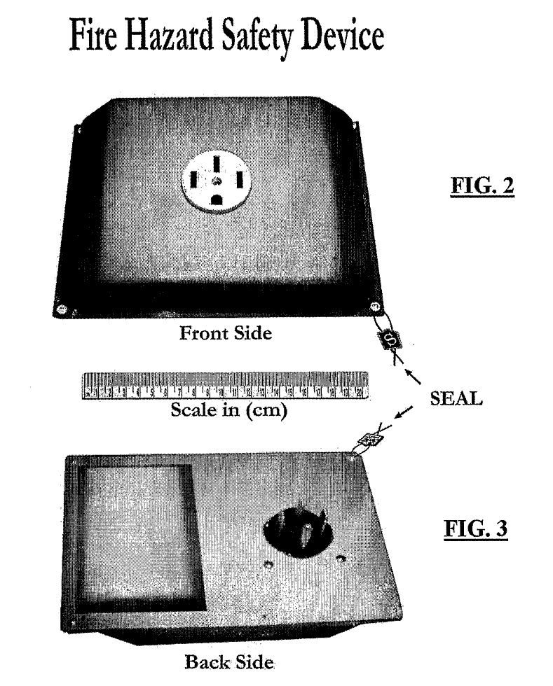

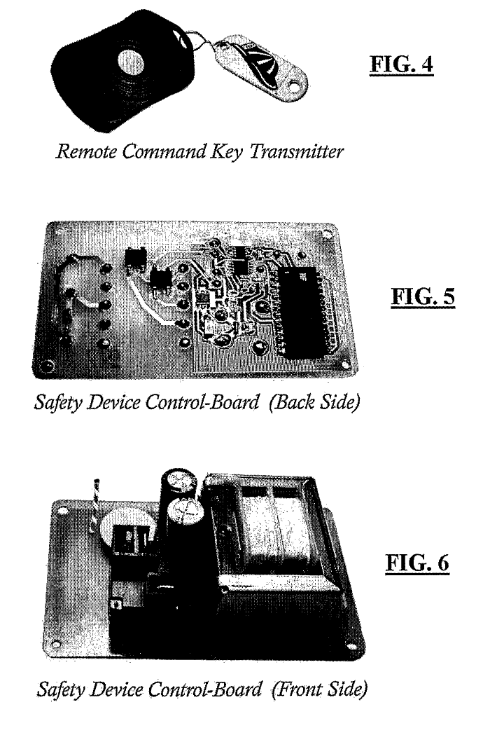

Referring to FIGS. 2 and 3, the known safety device is a self-contained unit having a male plug on the back side thereof for plugging it in an electrical power source of 220 Volts, and a female receptacle on the front side for receiving the appliance's plug (not shown). Preferably, the safety device is designed to prevent operation of the heating elements of a cooking appliance except when the user activates a timing function which enables their operation for a preset time period. The user must reset the timing function before expiration of the time period to keep the heating elements operating. The safety device is also designed so that the 120V-operated equipment of the cooking appliance is unaffected by it.

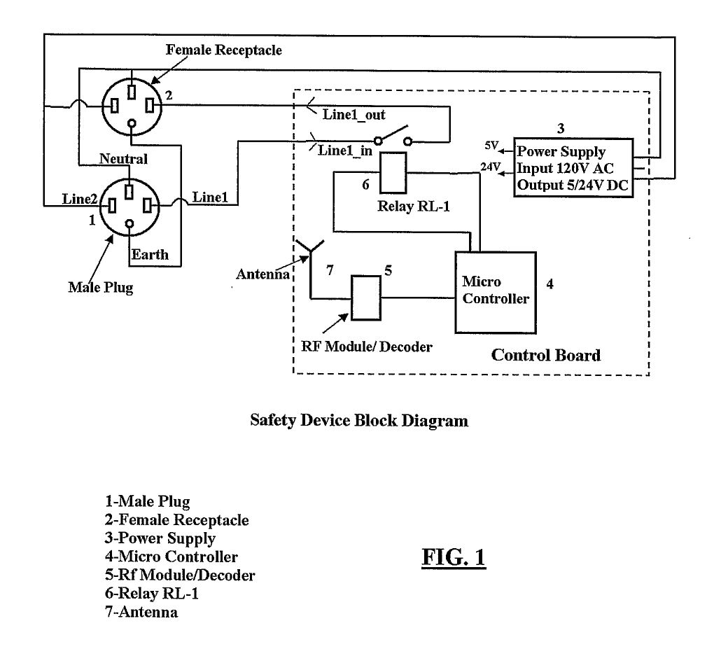

Referring to FIG. 1, the known safety device has a relay circuit connected between one of the power prongs of the male plug 1 and a corresponding one of the contacts of the female receptacle 2. The 120V-operated equipment of the cooking appliance is powered between the undisturbed power line in the safety device and the neutral line. The relay 6 is normally in open state and is responsive to a control signal generated by a micro-controller providing a timing function. The control signal triggers the relay into closed state as long as the time period measured by the timing function of the micro-controller has not elapsed. The relay gets back into open state whenever the timing function stops. The micro-controller may be connected to a RF module/decoder provided with an antenna for receiving a timer activating/reset signal from a remote control as shown in FIG. 4. The remote control has a single push-button operable by the user of the cooking appliance for resetting the timing function and triggering a new count-down process for the preset time period. The safety device has a power supply circuit connected to the undisturbed power line and the neutral line and providing the required power supply for the electronic and electrical components of the safety device.

Referring to FIGS. 2 and 3, the safety device may be especially used for insurance-related purposes. In such a case, the safety device would be installed by an authorized technician who would place a seal lock on one of the screws securing the safety device to the wall when plugged in the usual power outlet for the cooking appliance. The seal lock would provide evidence of any tampering to by-pass the safety device, in a similar way to seal locks put on electrical company meters.

Referring to FIG. 1, the male plug's 1 pin Line1 is connected to relay contact NO and the output of the relay is connected to female receptacle 2. Relay coil is driven by timer with approved time as set by a Safety Regulation Specification Standard.

The time ON is announced by two (2) beeps. Before the safety time expires multiple beeps are sounded and a user can in this remaining time extend the Run Time Program by the same Approved ON Time by sending the signal from remote control (single key) one-touch. This cycle could be repeated all the time set-up by the user by original home appliance settings, therefore the user sets up the cooking process by entering time, temperature and other features as convection bake, broil, tender cook, etc.

The purpose of this device is to automatically cut-off one (1) line of the power after a determined number of minutes specified by the safety specification standard.

The known safety device prevents a home cooking appliance to continue the cooking process with out user supervision.

The known fire hazard safety device complements the electromechanical or electronic controls for home appliances to eliminate fire hazard conditions such as: when running out of control due to incorrect program setting; when a user is not present in the surrounding of the controlled appliance; when the condition of the appliance causes a fire condition; or by misused domestic appliance, i.e. heating a home by electric oven or cook-top. The safety device periodically checks the user's intention to continue the set-up functions for cooking.

The safety device is a self-contained unit comprising of a male plug 40A-125/250V on the back side of the safety device with 50A-125/250V female receptacle on the front side of the safety device.

Line 2 (or 1) from the male plug is connected directly to contact 2 (or 1) of the female receptacle. The connecting wire is branched directly to the power supply terminal. The neutral wire is connected the same way from male plug to neutral connector of female receptacle with branch connected to the power supply terminal.

Installed inside the self-contained box is a Control Board containing reprogrammable micro-controller, micro-encoder, RF module, antenna and main relays 1/30A, 240VAC or 2/30A, 240VAC.

Line 1 (or 2) of male plug is connected to NO terminal of Relay RL-1 and the solid contact of RL-1 is connected to Line 1 (or 2) contact terminal of female receptacle.

During the time when there is no activity with the home appliance the power circuit is open. Only Line 2 (or 1) and neutral line are solidly connected between male plug and female receptacle. Neutral connection is branched to Control Board neutral terminal of power supply.

Relay RL-1 is controlled by pre-programmed micro-controller. Program of the micro-controller is activating the time relay. The ON/OFF time varies according to the safety regulations standards as specified by states (CA, USA) and municipal fire departments.

The timer is wirelessly controlled by the remote command key transmitter shown in FIG. 4. The remote command key transmitter is used for remote control of the safety device. Selectable addressing provides security and allows distinct transmitter-receiver relationships (CA or USA). The receiver/decoder is paired with a decoder micro-controller. The key transmitter may be configured to meet specific requirements. Remote control/command and keyless entry combines an RF receiver with an on-board decoder and antenna.

After the safety device is installed permanently by an authorized or certified company. The electric oven, range, cook-top or combination electric oven c/w cook-top could be plugged into 120/240V receptacle.

The person using the heating appliance can now set-up functions for cooking process using complete instructions from the owner's manual. Time of day, minute minder and oven/range light could be set-up at anytime without activating safety device. Now the cooking/baking process could be started by activating remote command key transmitter. The Receiver/Decoder announced by several beeps that the Safety Time ON is activated and set-up cooking process started. The safety time expires after a predetermined setting, this is indicated by a number of beeps to get the attention of the user to confirm that the appliance should continue the cooking process. The user will confirm this by pressing the remote command key transmitter. Confirmation of acceptance is also announced by predetermined number of beeps. This process will continue after the setting program in the home appliance is complete or when the person using the heating appliance decides not to continue the cooking/baking process using the appliance control device or by not confirming the process by pressing key of RF transmitter. The power will be cut-off by electronic safety device after the safety time expires and is not extended by the user. The safety time cycle could be repeated during the cooking process entered by the user.

The present invention relates to improvements to the above-described technology which could be used in combination therewith or in replacement thereof, as can be easily understood by a person skilled in the art when referring to the accompanying drawings.

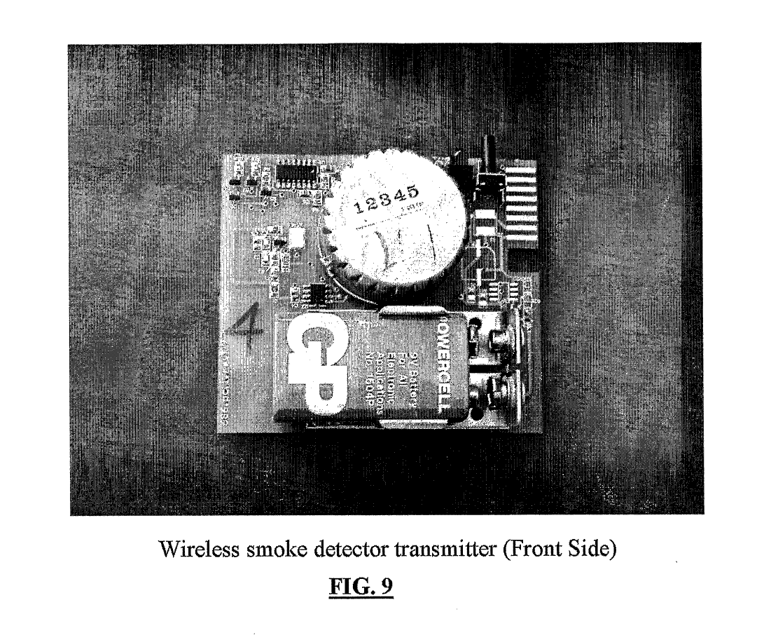

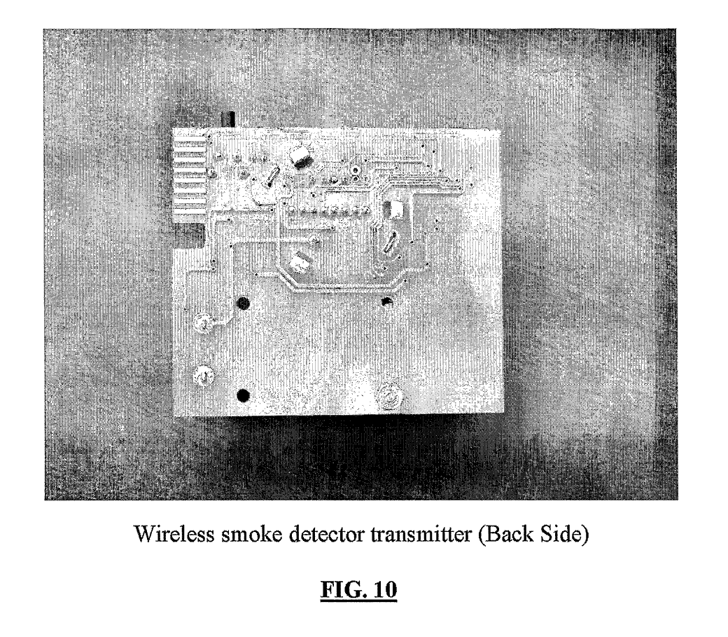

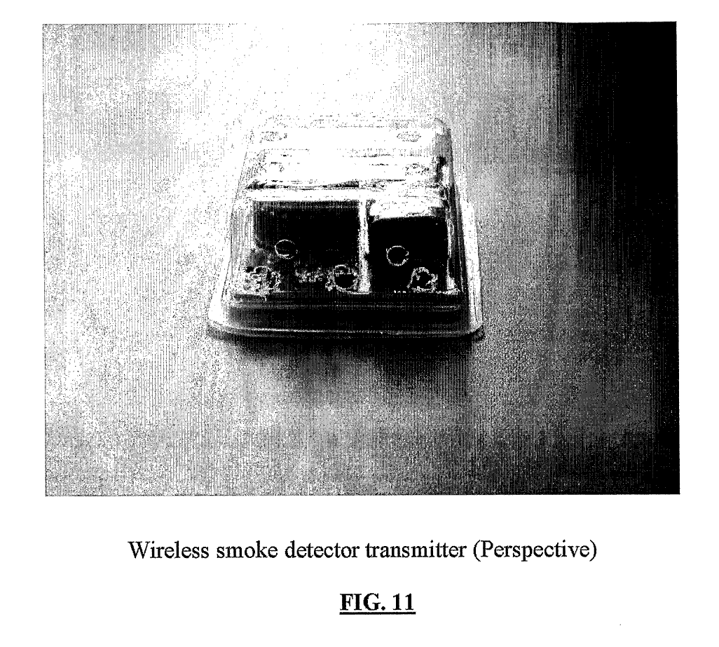

Indeed, referring now to FIGS. 7 to 11, there is shown a power cut-off system for cutting a 220V power supply (or any other voltage value) to an electrical device (in this example an oven) while maintaining a 110V power supply (or any other voltage value) to the electrical device, according a preferred embodiment of the present invention. The power cut-off system has a control-board connected to the 220V power supply of the electrical device and providing 110V and 220V to the electrical device. The control-board includes a transponder for sending and receiving wireless signals. The control-board may be similar to the one known in the prior art and described above. As best shown in FIGS. 7 and 8, the control-board 10 is preferably integrated in the oven power cord. The power cut-off system also includes a smoke detector device 12 (wireless smoke detector transmitter) for detecting smoke and sending a wireless signal to the transponder of the control-board to cut-off the 220V power supply to the electrical device while maintaining the 110V power supply to the electrical device. In this way the oven heating elements working on 220V, i.e. the bake elements and cook tops elements are shut-off while the other components working on 110V i.e. clock, lights, etc. remain powered on, which is very advantageous for obvious reasons known in the art.

In a preferred embodiment, the smoke detector is powered with a battery. In this case, it could be advantageous to monitor the level of the battery in order to detect a low-battery or a no-battery state. Should it happen, the transponder of the control board is advantageously adapted to detect this state and to cut-off the 220V power supply to the electrical device until the battery of the smoke detector is replaced.

In a further embodiment, the smoke detector is advantageously provided with a clock or any other convenient means that will provide to the user an easy visual means for indicating that the smoke detector is in a no-battery state.

Throughout the present description, the system of the present invention has been described for use with electric devices but it is worth mentioning that it could also be used with a gas range, also called a gas stove, provided with an electric control valve controlling the gas inlet.

Of course, numerous modifications could be made to the above-described embodiments without departing from the scope of the invention, as defined in the appended claims.

1. A power cut-off system for cutting a power supply of a given voltage from an electrical device present in a first environment, the system comprising:
a control-board unit operatively connected to the power supply of the electrical device, the control-board unit including a transponder for sending and receiving wireless signals; and
a smoke detector operatively connected to the control-board unit and configured for detecting levels of smoke in a second environment and sending at least one wireless signal to the control-board unit in order to cut-off the power supply of the electrical device upon attainment of a given threshold of smoke level in the second environment.

2. A system according to claim 1, wherein the power supply includes main and auxiliary power supplies for providing main and auxiliary sources of power supply to the electrical device.

3. A system according to claim 2, wherein the control-board unit is operatively connected to the main power supply of the electrical device, and wherein the smoke detector is further configured for sending at least one wireless signal to the transponder of the control-board unit in order to cut-off the main power supply of the electrical device while maintaining the auxiliary power supply thereof upon attainment of the given threshold of smoke level in the second environment.

4. A system according to claim 2, wherein the main and auxiliary power supplies provide voltages of different values.

5. A system according to claim 4, wherein the voltage of the auxiliary power supply is lower than the voltage of the main power supply.

6. A system according to claim 5, wherein the main and auxiliary power supplies provide voltages of about 220V and about 110V respectively.

7. A system according to claim 1, wherein the control-board unit includes a control-board that is integrated into a power cord of the electrical device.

8. A system according to claim 1, wherein the electrical device is a household electrical device.

9. A system according to claim 1, wherein the electrical device is selected from the group consisting of oven, stove, cook-top, and the like.

10. A system according to claim 1, wherein the first environment and the second environment are the same room environment.

11. A method of cutting a power supply of a given voltage from an electrical device present in a first environment, the method comprising the steps of:
a) providing a control-board unit operatively connected to the power supply of the electrical device, the control-board unit including a transponder for sending and receiving wireless signals; and
b) providing a smoke detector operatively connected to the control-board unit and configured for detecting levels of smoke in a second environment and sending at least one wireless signal to the control-board unit in order to cut-off the power supply of the electrical device upon attainment of a given threshold of smoke level in the second environment.

12. A method according to claim 11, wherein the power supply includes main and auxiliary power supplies for providing main and auxiliary sources of power supply to the electrical device.

13. A method according to claim 12, wherein the control-board unit is operatively connected to the main power supply of the electrical device, and wherein the smoke detector is further configured for sending at least one wireless signal to the transponder of the control-board unit in order to cut-off the main power supply of the electrical device while maintaining the auxiliary power supply thereof upon attainment of the given threshold of smoke level in the second environment.

14. A method according to claim 12, wherein the main and auxiliary power supplies provide voltages of different values.

15. A method according to claim 14, wherein the voltage of the auxiliary power supply is lower than the voltage of the main power supply.

16. A method according to claim 15, wherein the main and auxiliary power supplies provide voltages of about 220V and about 110V respectively.

17. A method according to claim 11, wherein the control-board unit includes a control-board that is integrated into a power cord of the electrical device.

18. A method according to claim 11, wherein the electrical device is a household electrical device.

19. A method according to claim 11, wherein the electrical device is selected from the group consisting of oven, stove, cook-top, and the like.

20. A method according to claim 11, wherein the first environment and the second environment are the same room environment.
